(19) United States
(12) Patent Application Publication
(10) Pub. No.: US 2004/0178015 A1
(43) Pub. Date: Sep. 16, 2004

(54) Muffler with variable damping characteristic

(76) Inventors: Dirk Wiemeler, Edenkoben (DE); Rico Weinert, Gommersheim (DE); Alexander Schinko, Mannheim (DE); Richard Veneziano, Jackson, MI (US); Pavel Robles, Jackson, MI (US); George Labarge, Tecumseh, MI (US)

Correspondence Address: HARNESS, DICKEY & PIERCE, P.L.C., P.O. BOX 828, BLOOMFIELD HILLS, MI, 48303, US

(21) Appl. No.: 10/677,554

(22) Filed: Oct. 2, 2003

(30) Foreign Application Priority Data
Mar. 14, 2003 (DE) 10311201.4

(51) Int. Cl. F01N 1/00; F16K 17/00

(52) U.S. Cl. 181/237

(57) ABSTRACT

The Invention relates to mufflers with variable damping characteristic for motor vehicles with internal combustion engine, comprising a housing (20) with at least one gas pipe (1), terminating in the housing (20), and at least one valve whose closure element (3) closes the end (2) of the pipe (1) in rest position. The closure element (3) is a disk, seated on a guide rod (4). The guide rod (4) is guided in a guide sleeve (5) and performs a lifting mouvement. The spring (8) is positioned in a valve housing (10) which is gastight and connected in gastight manner to the muffler housing (20).

As soon as the pressure in the gas pipe (1) is high enough, the valve disk (3) opens against the force of the spring (8).

The Invention relates to mufflers with variable damping characteristic for motor vehicles.

Mufflers with variable damping characteristic are disclosed in U.S. Pat. No. 4,484,659, U.S. Pat. No. 5,614,699, or also US 2002/0033303 A. All of these mufflers have a housing into which the exhaust gases of an internal combustion engine are passed by way of an inlet pipe and passed out by way of an outlet pipe. In the interior of the muffler housing, additional pipes are provided.

Further, in the interior of the muffler housing a valve is provided. This has a spring-loaded closure element, which in rest condition, i.e. at low gas flow rate, for example when the engine is idling, closes a gas port. This compels the exhaust gases to traverse a long distance, sharply damping noise interference, inside the muffler housing.

If the rotational speed of the internal combustion engine is increased, the flow of exhaust gas increases. Hence, a higher pressure acts on the closing element of the valve, so that it opens against the action of the spring. The exhaust gases flow through the opening, now clear, the pressure drop in the muffler housing recedes, and the engine power is increased.

U.S. Pat. No. 4,484,659 discloses several valve designs.

A first design employs a valve disk of spring steel, attached on one side.

A second design employs a valve disk attached to a tension spring.

The third design employs a swing flap attached by a membrane chamber whose control pressure is generated by a Venturi nozzle.

The fourth design employs a rotary slide moved by way of a membrane chamber whose control pressure is generated by a Venturi nozzle.

US 2002/033303 A, as closure element, employs a flap, which is spring loaded.

U.S. Pat. No. 5,614,699 likewise employs a spring-loaded swing flap.

Since in all these designs the valve is accommodated in the interior of the muffler housing, all its parts are exposed to the heat, the aggressive elements and the pressure pulsations of the exhaust gas. The several parts must therefore be made of temperature-resistant and oxidation-free material. Therefore these designs have failed to find acceptance in practice.

The object of the present invention, then, is to specify an acoustic damper of the kind initially mentioned, making possible a long service life even with use of economical materials.

This object is accomplished by an acoustic damper having the features:

a housing,

at least one gas pipe terminating in the housing,

at least one valve whose closure element closes the end of the pipe in rest position with the aid of a spring,

the valve executes a lifting motion,

the closure element is a disk,

the disk is seated on a guide rod,

the guide rod is guided in a guide sleeve,

the spring is positioned in a valve housing,

the valve housing is gastight and connected in gastight manner to the acoustic damper housing.

The essential advantage of the present invention is based on the fact that the valve housing in which the temperature-sensitive spring is accommodated is positioned outside of the muffler housing. The hot exhaust gases cannot directly heat the valve housing. Furthermore, the valve housing is cooled by the airstream. Since the valve housing is gastight and connected gastight to the muffler housing, no exhaust gases can escape.

According to one embodiment of the invention, a spring guide disk is mounted at the spring end of the guide rod. The spring thereby gains a secure seat. Besides, the spring action is transmitted symmetrically to the guide rod, so that the latter cannot jam in the guide sleeve.

Additionally, a wire knit ring may be placed on the spring end of the guide rod. It will act as a damping element and suppress rattling noises.

Preferably, the end of the pipe is tapered, and so is the disk. Thus in rest position, the closure will be securely seated on the end of the gas delivery pipe.

According to one embodiment of the invention, the spring is conical. The spring properties of such a conical spring are optimally adapted to the opening and closing characteristics of the valve disk.

With reference to the drawings, the invention will be illustrated in more detail in the form of an embodiment by way of example. In each instance quite schematically,

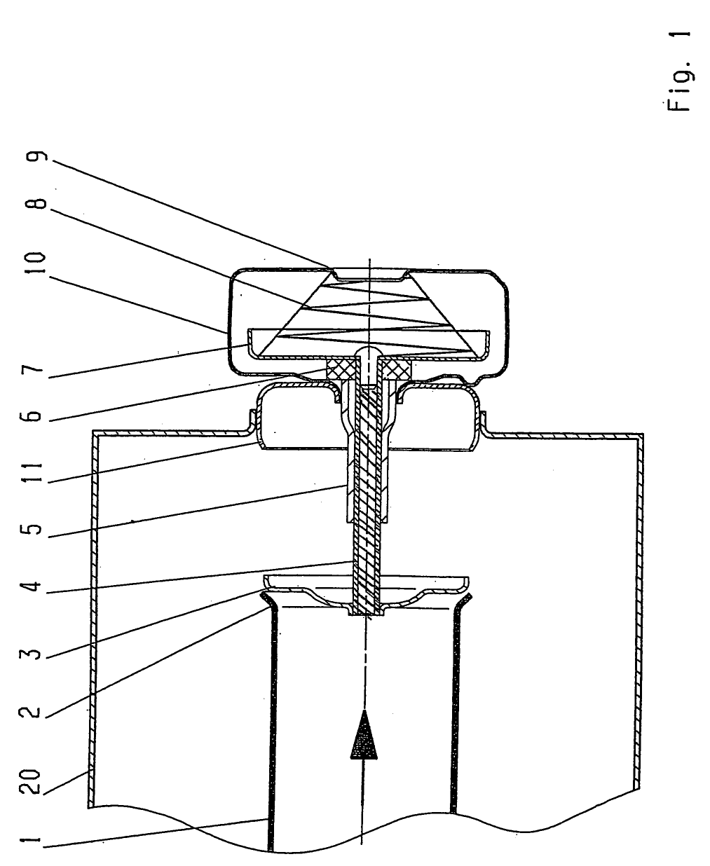

FIG. 1 in section, shows a portion of an acoustic damper with variable damping characteristic, only the valve portion being represented, and

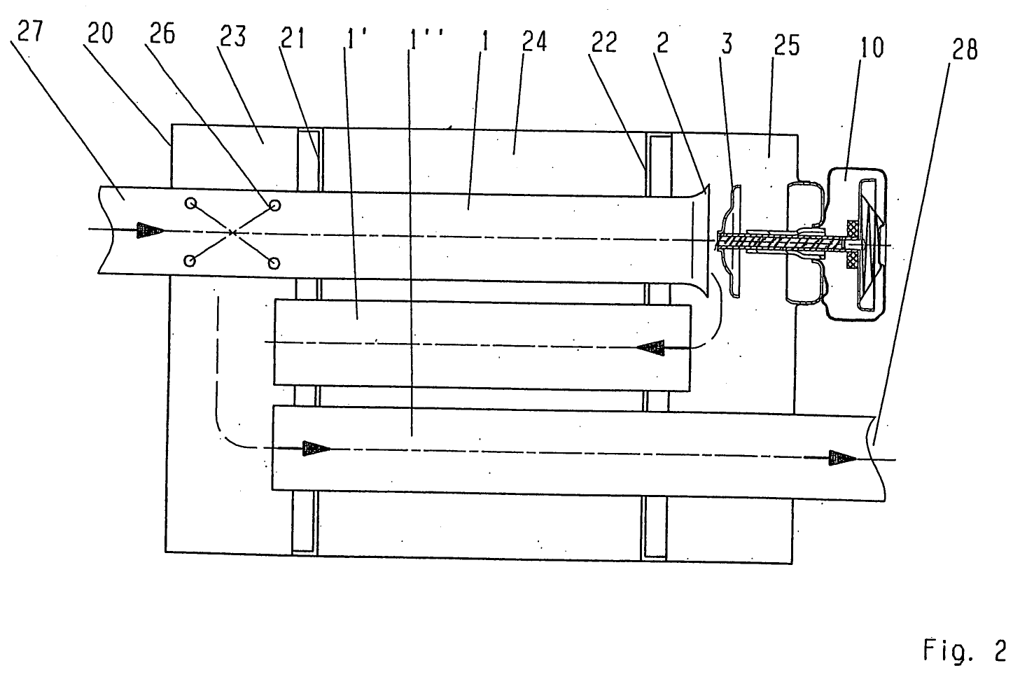

FIG. 2 shows a longitudinal section of the complete acoustic damper.

FIGS. 1 and 2, quite schematically and in section, show an muffler housing 20 whose interior is divided by transverse partitions 21, 22 into three chambers 23, 24, 25. A pipe 27 carries exhaust gases into the housing 20, and a pipe 28 carries the exhaust gases out of the housing 20 again.

In the interior of the housing 20, three pipes 1, 1′, 1″ carrying gas are seen. The pipe 1 has a perforation 26, through which the gases can escape, in the neighborhood of the first chamber 23.

As FIG. 1 shows to a large scale, the end 2 of the first gas pipe 2 conically widened.

A likewise conical valve disk 3 closes the end 2 of the pipe 1. The valve disk 3 is mounted on a guide rod 4, guided in turn in a guide sleeve 5. The guide sleeve 5 is held by an assembly sleeve 11 mounted gastightly in the wall of the acoustic damper housing 20. Outside of the muffler 20, a valve housing 10 is seen. In it, there is a conical spring 8 held by a spring suspension 9. The other end of the spring 8 bears upon a spring guide disk 7 mounted at the end of the guide rod 4. In this way, the spring 8 gains a secure support and distributes its force symmetrically to the guide rod.

Between the spring guide disk 7 and the valve housing 10, a ring 6 of wire knit is placed on the guide rod 4. This ring 6 serves as damping element and prevents noise interference.

As FIG. 1 shows, the valve disk 3 in rest condition is subject to the action of the spring 8 at a short distance from the end 2 of the pipe 1. Therefore, the exhaust gases flow through this annular gap of small flow cross-section. The main quantity of the exhaust gases leaves the pipe 1 by way of the perforation 26 (FIG. 2), if present, flows through the first chamber 23 into the gas pipe 1″, and leaves the muffler housing 20 by way of the outlet pipe 28.

As soon as the rotational speed of the internal combustion engine (not shown) increases, the quantity of exhaust gas flowing in through the pipe 27 into the muffler housing 20 increases. This increases the jet impact on the valve disk 3. As soon as the pressure is high enough, the valve disk 3 opens against the force of the spring 8 and clears the way for the exhaust gases. This is shown in FIG. 2. Now the exhaust gases flow out of the pipe 1 into the third chamber 25, thence through the second gas pipe 1′ into the first chamber 23, and leave the latter by way of the pipe 1″.

The entire disclosure of German Patent Application No. 10311201.4 filed Mar. 14, 2003, is incorporated by reference.

1. Muffler with variable damping characteristics for motor vehicles with internal combustion engine, comprising
a housing (20),
at least one gas pipe (1) terminating in the housing (20),
at least one valve whose closure element (3) closes the end (2) of the pipe (1) in rest position with the aid of a spring (8), characterized by the features:
that the valve executes a lifting motion,
that the closure element is as disk (3),
that the disk (3) is seated on a guide rod (4),
that the guide rod (4) is guided in a guide sleeve (5),
that the spring (8) is positioned in a valve housing (10),
that the vale housing (10) is
gastight
and connected in gastight manner to the muffler housing (20).

2. Muffler according to claim 1, characterized by the feature
that a spring guide disk (7) is mounted at the spring end of the guide rod (4).

3. Muffler according to claim 1 or 2, characterized by the feature
that a ring (6) of wire knit is placed on the spring end of the guide rod (4).

4. Muffler according to any of claims 1 to 3, characterized by the features
that the end (2) of the tube (1) is conical,
that the plate (3) is likewise conical.

5. Muffler according to any of claims 1 to 4, characterized by the feature
that the spring (8) is conical.
